(19) United States
(12) Patent Application Publication
(10) Pub. No.: US 2022/0347903 A1
(43) Pub. Date: Nov. 3, 2022

(54) MOULD STRUCTURE WITH FAST REPLACEMENT OF MOULD CORE

(71) Applicant: RAYSPERT PRECISION INDUSTRIAL INC, Tainan (TW)

(72) Inventors: Shun-Fu Lin, Tainan (TW); Yu-Chang Su, Tainan (TW); Shin-Hsiang Yen, Tainan (TW)

(21) Appl. No.: 17/385,942

(22) Filed: Jul. 27, 2021

(30) Foreign Application Priority Data
Apr. 29, 2021 (TW) 110115501

(51) Int. Cl. B29C 45/26

(52) U.S. Cl. CPC B29C 45/2673; B29C 45/2606

(57) ABSTRACT

Provided is a mold structure with a fast replacement of a mold core, including an upper mold base and a lower mold base corresponding to the upper mold base. The upper mold base is provided with at least one upper mold base, wherein the bottom of the upper mold base is provided with a push-pull device, the push-pull device includes a pressure cylinder and a push-pull rod capable of expansion and contraction and the upper mold core is driven by the expansion and contraction of the push-pull rod, and is relatively separated from or embedded in the upper mold base, and wherein the bottom of the upper mold core is provided with a chute, and the upper mold core is operatively coupled with or separated from the push-pull rod by the chute. Consequently, the action of replacing the mold core is performed.

### BACKGROUND OF THE INVENTION

### 1. Field of the Invention

The present disclosure relates to an mold, and particularly relates to a structure with fast mold core replacement.

### 2. The Prior Arts

According to many items in daily life, such as automobiles, motorcycles, cabinets, tables and chairs, mobile phones, cameras, lenses, etc., finished products are often produced through molding machines, such as injection molding machines, blow molding machines, etc. Various products need to be processed and formed by molds. Hence, it is necessary to replace different molds to produce different styles of products. In addition, some products can be produced only by replacing the mold core. For example, lenses with small differences in similar products can be produced by using the same mold base to replace mold cores with different optical powers. Alternatively, the mold core of the mold is damaged during the production process and needs to be replaced with a new mold core.

However, most of the more cores are fixed to the mold based by bolts. Hence, to replace the mold core, the molding machine must be stopped. The mold is detached from the molding machine by manpower, and the mold is lifted off with a crane. After that, the mold engineer disassembles all the molds, takes out the mold core that need to be replaced, and replaces them with new mold cores. In this way, it take a lot of time and manpower to disassemble the mold from the molding machine and then install a new mold on the molding machine. When a small number of finished products are produced, the time it takes to replace the mold core is even more problematic. Moreover, if the molding machine waits for too long to replace the mold core, the raw materials in the material tube will be cracked and a cleaning process of the material tube must be carried out. Besides, in addition to time-consuming, it also increases production costs. As such, how to provide a mold that can quickly replace the mold core becomes one of the problems to be improved at present.

### SUMMARY OF THE INVENTION

In order to achieve the above objective, according to a preferred embodiment, the present disclosure provides a mold structure with a fast replacement of a mold core, which can quickly disassemble or replace the mold core, shorten the time for mold core replacement, and reduce the time spent in the process of disassembly and assembly.

According to an embodiment of the present disclosure, the mold structure with the fast replacement of the mold core mainly includes the following technical features.

An upper mold base and a lower mold base corresponding to the upper mold base are provided. At least one upper mold core is provided inside the upper mold base, and at least one lower mold core is provided inside the lower mold base and corresponded to the upper mold core.

The upper mold base is provided with a first push-pull device corresponding to a bottom of the upper mold core, the first push-pull device includes a first pressure cylinder and a first push-pull rod capable of expansion and contraction arranged in the first pressure cylinder, one end of the first push-pull rod is a first free end and protrudes out of the first pressure cylinder, and the upper mold core is driven by the expansion and contraction of the first push-pull rod, and is relatively separated from or embedded in the upper mold base.

The bottom of the upper mold core is provided with a first chute, and the upper mold core is operatively coupled with or separated from the first free end of the first push-pull rod by the first chute.

The upper mold core is separated from the upper mold base by the push-pull device, and the upper mold core is taken out or replaced in a sliding manner, thereby achieving the purpose or rapid disassembly and replacement of the mold core, and shortening the time for mold core replacement.

### BRIEF DESCRIPTION OF THE DRAWINGS

FIG. 1 is a three-dimensional schematic diagram of the present disclosure.

FIG. 2 is a three-dimensional exploded schematic diagram of the present disclosure.

FIG. 3 is a three-dimensional exploded schematic diagram showing the pushing device and the upper mold core of the present disclosure.

FIG. 4 is a three-dimensional exploded schematic diagram showing the upper mold base of the present disclosure.

FIG. 5 is a cross-sectional view taken the line A-A of FIG. 1 according to the present disclosure.

FIG. 6 is a three-dimensional schematic diagram showing the upper mold base of the present disclosure.

FIG. 7 is a cross-sectional view taken along the line B-B of FIG. 6 and a schematic diagram of the operation according to the present disclosure.

FIGS. 8, 9 and 10 are schematic diagrams showing the continuous operation of the upper mold core of the present application.

FIG. 11 is a three-dimensional schematic diagram showing the lower mold base of the present disclosure.

FIGS. 12 and 13 show cross-sectional views taken along the line D-D of FIG. 11 and a schematic diagram of the operation according to the present disclosure.

FIG. 14 is a schematic plan view showing the upper mold core of the present application.

FIG. 15 shows schematic diagrams of a centered lens and an off-center lens according to the present disclosure.

### DETAILED DESCRIPTION OF THE PREFERRED EMBODIMENT

The following is a specific embodiment to illustrate the implementation of the present disclosure. Persons skilled in the art can easily understand the other advantages and effects of the present disclosure from the disclosure in the specification.

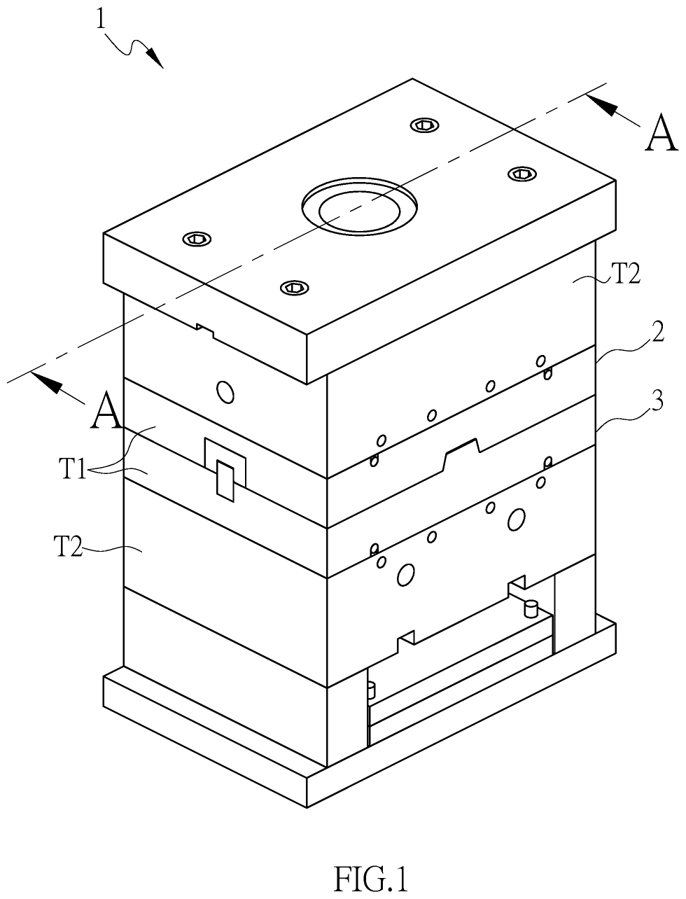

Please refer to FIGS. 1-5, which show a preferred embodiment of the present disclosure with a mold structure capable of quickly replacing mold cores. The mold 1 mainly includes an upper mold base 2 and a lower mold base 3 corresponding to the upper mold base 2, wherein at least one upper mold core 4 is provided inside the upper mold base 2, and at least one lower mold core 5 is provided inside the lower mold base 3 and corresponded to the upper mold core 4. The present disclosure does not limit the types of finished products produced by the mold 1, which can be, for example, products produced by injection molding machines, such as automobile, motorcycle parts or casting, mobile phone cases, daily necessities, mirror frames or lenses, etc. The drawings and descriptions of the present disclosure take the production of lenses as an example, but are not limited thereto.

The upper mold base 2 and the lower mold base 3 can be operably aligned or separated, and the aligned surface of the upper mold base 2 is provided with two first fitting parts. The aligned surface of the lower mold base 3 is provided with two second fitting parts 30 corresponding to the first fitting parts 21. Accordingly, the first fitting parts 21 and the second fitting parts 30 are aligned in the male and female aligning manner such that the upper mold base 2 and the lower mold base 3 can be precisely aligned. Each of the first fitting parts 21 and each of the second fitting parts 30 can be integrally formed on the upper mold base 2 and the lower mold base 3, respectively. Alternatively, each of the first fitting parts 21 and each of the second fitting parts 30 may be fixed on the upper mold base 2 and the lower mold base 3 by screws, respectively, as shown in the drawings. In addition, the top of the upper mold core 4 is provided with an upper mold cavity 40, and the top of the lower mold core 5 is provided with a lower mold cavity 50. When the upper mold cavity 41 is aligned with the lower mold cavity 51, a molding chamber C is formed.

The upper mold base 2 is provided with at least one first mounting hole and at least one first assembling hole 23. A first channel 24 is provided between the first mounting hole 22 and the first assembling hole 23. The upper mold core 4 is arranged in the first assembling hole 21, and a first push-pull device 6 is arranged in the first mounting hole 22. The first push-pull device 6 includes a first pressure cylinder 61 and a first push-pull rod 62. One end of the first push-pull rod 62 is a first actuating end 621, which is arranged inside the first pressure cylinder 61. Another end of the first push-pull rod 62 is a first free end 622, which protrudes outside the first pressure cylinder 61 and penetrates into the first channel 24. The first free end 622 of the first push-push rod is radially provided with a first limiting part 623. The present disclosure does not limit the aspect of the first pressure cylinder 61, which may be a pneumatic cylinder or a hydraulic cylinder. The first pressure cylinder 61 has two first through holes 624 arranged at intervals and penetrating the wall surface of the first pressure cylinder 61. The first through holes 624 is respectively adjacent to the top and bottom of the first pressure cylinder 61. The upper mold base 2 is provided with two first passages 25 respectively connected to the first through holes 624. Each of the first passages 25 can be provided with a joint S to connect to a pressure pump B.

The upper mold core 4 is provided with a first chute 41. One side of the first chute 41 is radially provided with a first side opening 411. Another side of the first chute 41 is provided with a first stop surface 412. The bottom of the upper mold core 4 is provided with the first chute 41, and the first chute 41 is provided with a first lower opening 413. The width W1 of the first lower opening 413 is smaller than the width W2 of the first chute 42. A first step part 414 is provided in the first chute 41, and the first lower opening 413 connects with the first side opening 411 such that the first free end 622 of the first push-pull rod 62 penetrates the first lower opening 413 of the first chute 41. The first limiting part 623 is arranged in the first chute 41 and limited to the first step part 414, thereby restricting the axial displacement of the upper mold core 4 relative to the upper mold base 2.

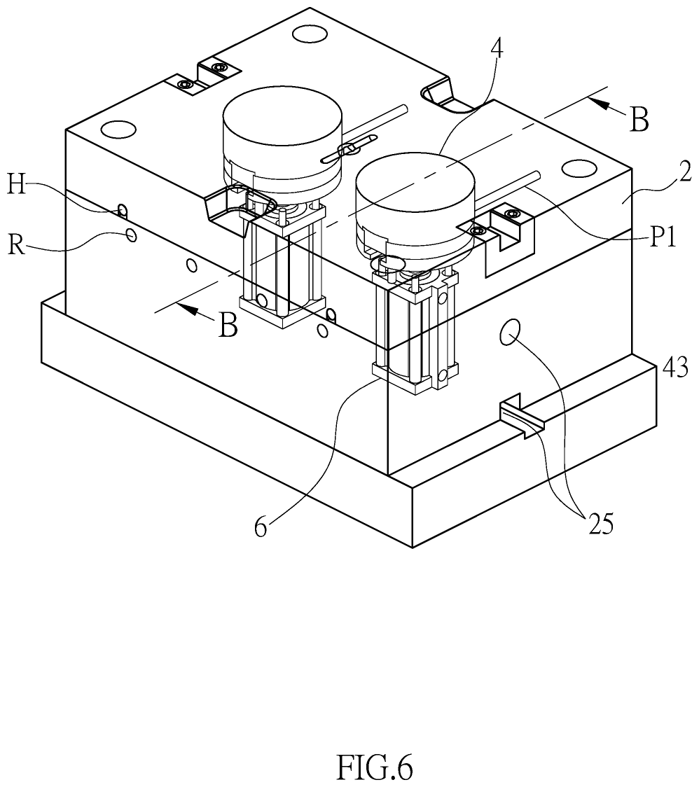

Please refer to FIGS. 6-10. The upper mold core 4 is radially provided with a first positioning slot 42. The upper mold base 2 is provided with a first pin hole 26 which is coaxially connected to the first positioning slot 42. A first positioning pin P1 is detachably inserted in the first positioning slot 42 and the first pin hole 26. As such, when the upper mold core 4 is cylindrical in the drawings, the first positioning pin P1 can be used to limit the radial rotational displacement of the upper mold core 4 relative to the upper mold base 2. In addition, when the upper mold core 4 has other shapes, such as cube or cuboid. It has a foolproof function and limits the axial displacement of the upper mold core 4 relative to the upper mold base 2.

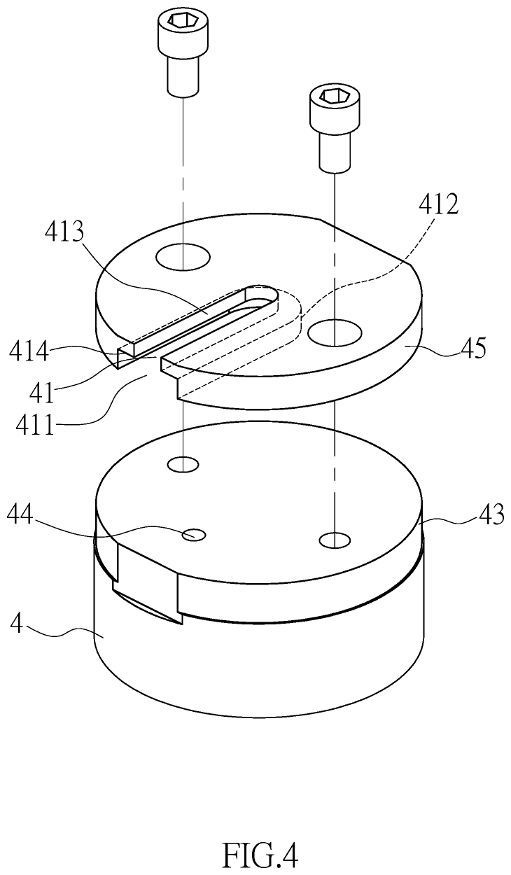

Moreover, the first chute 41 and the first positioning slot 42 can be integrally extended by the upper mold core 4 or as shown in FIG. 4. A first gasket 45 is assembled at the bottom of the upper mold core 4. The first gasket 45 has a predetermined thickness, and the first chute 41 is arranged on the first gasket 45. Accordingly, the first gasket 45 of the present disclosure can be replaced with different thicknesses to adjust the thickness of the finished lens without the need to replace the upper mold core 4 as a whole such that the upper mold core 4 can achieve the best use efficiency.

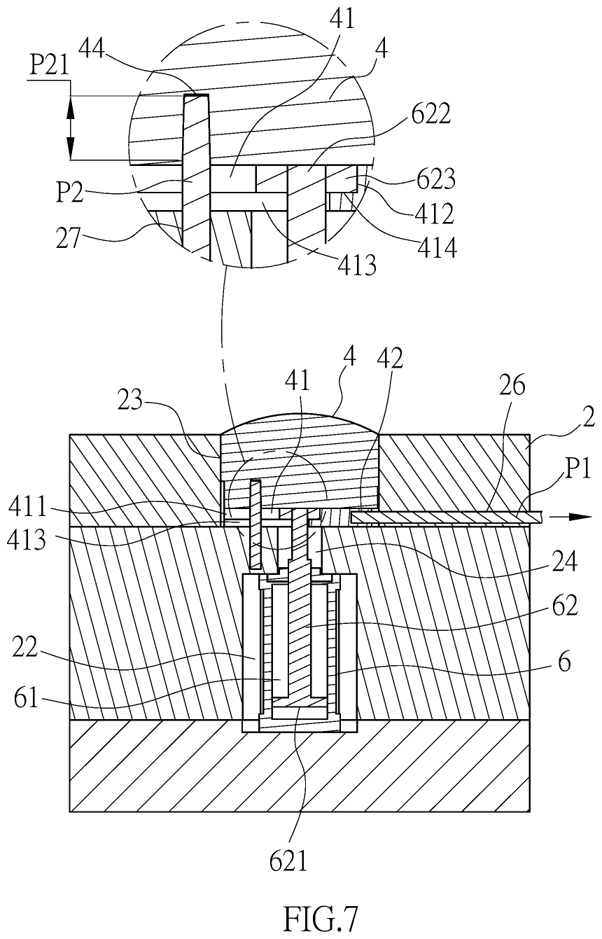

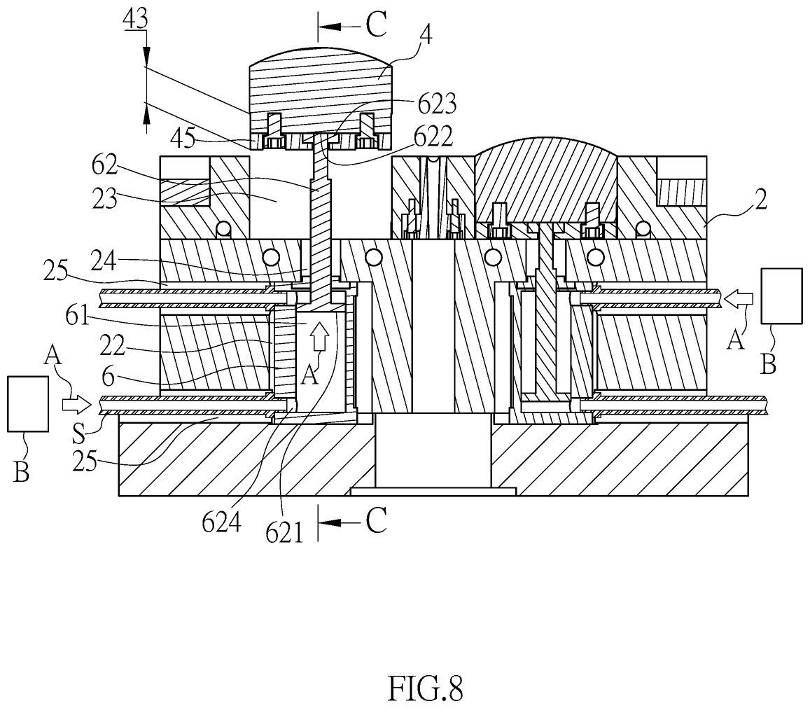

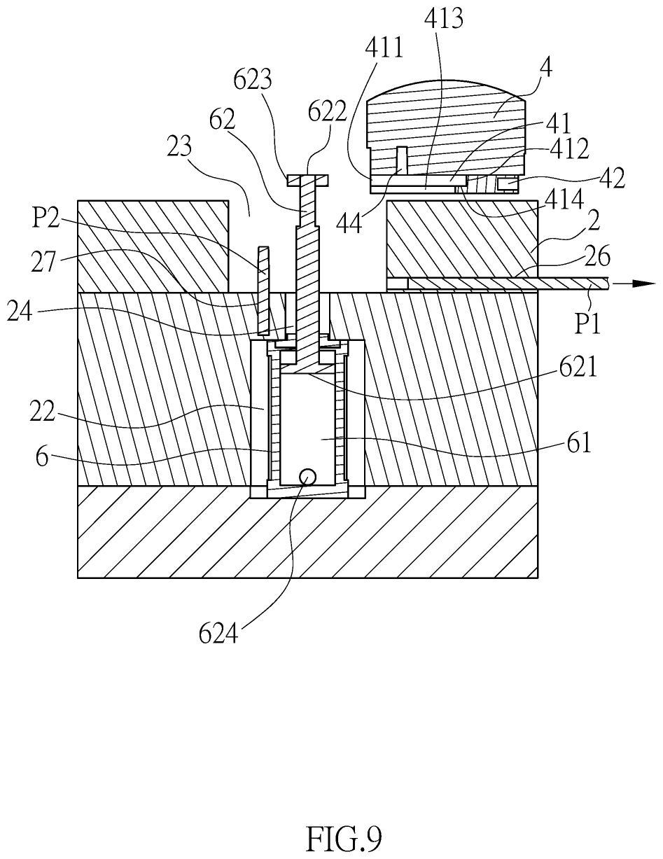

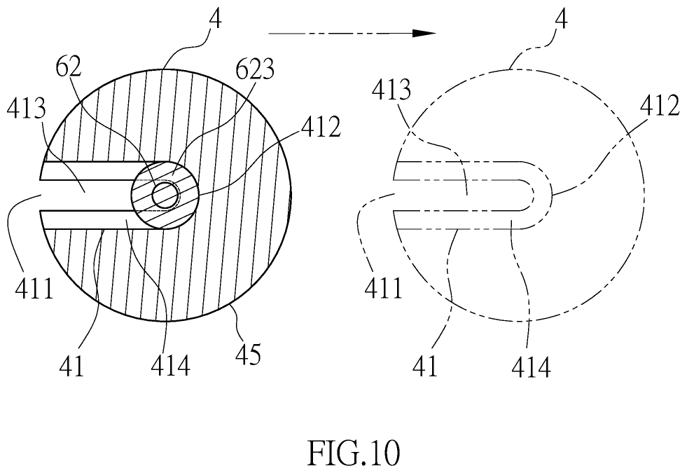

As mentioned above, when the upper mold core 4 is to be replaced, the first positioning pin P1 must be pulled out of the first positioning slot 42 of the upper mold core 4 as shown in FIG. 7. After that, as shown in FIG. 8, the pressure pump B enters the pressure A into the first pressure cylinder 61 through the first through hole 624 at the bottom of the first pressure cylinder 61 so as to push up the first push-pull rod 62 and make the first free end 622 extend out of the first pressure cylinder 61 to drive the upper mold core 4 out of the first assembly hole 23. Subsequently, as shown in FIGS. 9 and 10, the upper mold core 4 operably slides along the first side opening 411 of the first chute 41 to the first stop surface 412 such that the first limiting part 623 is separated from the first chute 41 through the first side opening 411. Consequently, the upper mold core 4 is separated from the first push-pull rod 62 and then the upper mold core 4 is disassembled to replace a new upper mold core 4.

The replaced upper mold core 4 is inserted into the first push-pull rod 62 through the first side opening 411 of the first chute 41, and slides the upper mold core 4 to the outer edge of the first limiting part 623 of the first push-pull rod 62 to abut against the first stop surface 412. The pressure pump B enters the pressure A into the first pressure cylinder 61 through the first through hole 624 at the top of the first pressure cylinder 61 to return the first push-pull rod 62 to its original position. The first free end 622 is relatively retracted and the upper mold core 4 is inserted into the first assembly hole 23. The first positioning pin P1 is embedded in the first position slot 42 to complete the procedure of replacing the upper mold core 4. In the process of replacing the upper mold core, the present disclosure can quickly and conveniently replace the upper mold core 4 without disassembling screws in the whole process, thereby solving the problem of time-consuming mold core replacement in the prior art.

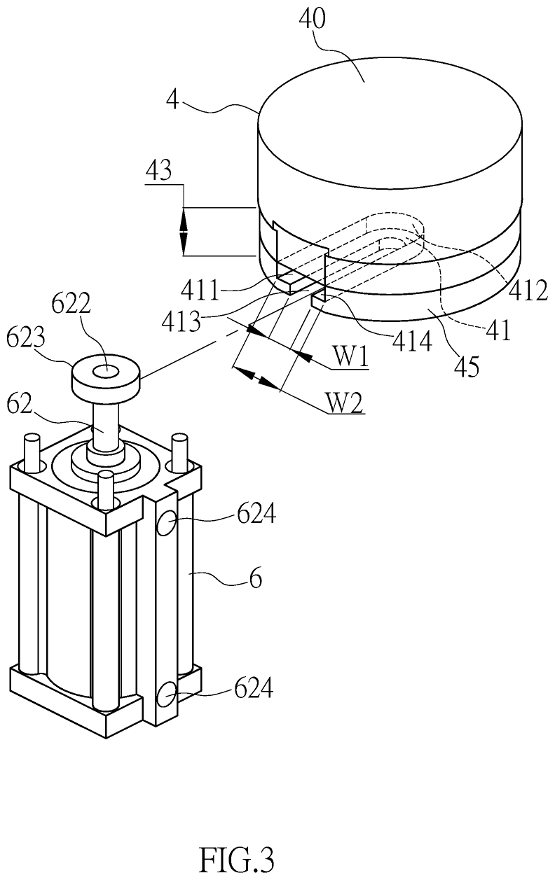

As shown in FIGS. 3, 4 and 8, in order to improve the smoothness when the upper mold core 4 is inserted into the first assembly hole 23, the bottom of the upper mold core 4 has a first introduction section 43. The outer diameter of the first introduction section 43 is smaller than the outer diameter of the upper mold core 4 and smaller than the inner diameter of the first assembly hole 23. In this embodiment, the range of the first introduction section 43 covers the bottom of the upper mold core 4 and the first gasket 40. Through the arrangement of the first introduction section 43, the problem of interference is reduced when the upper mold core 4 is inserted into the first assembly hole 23.

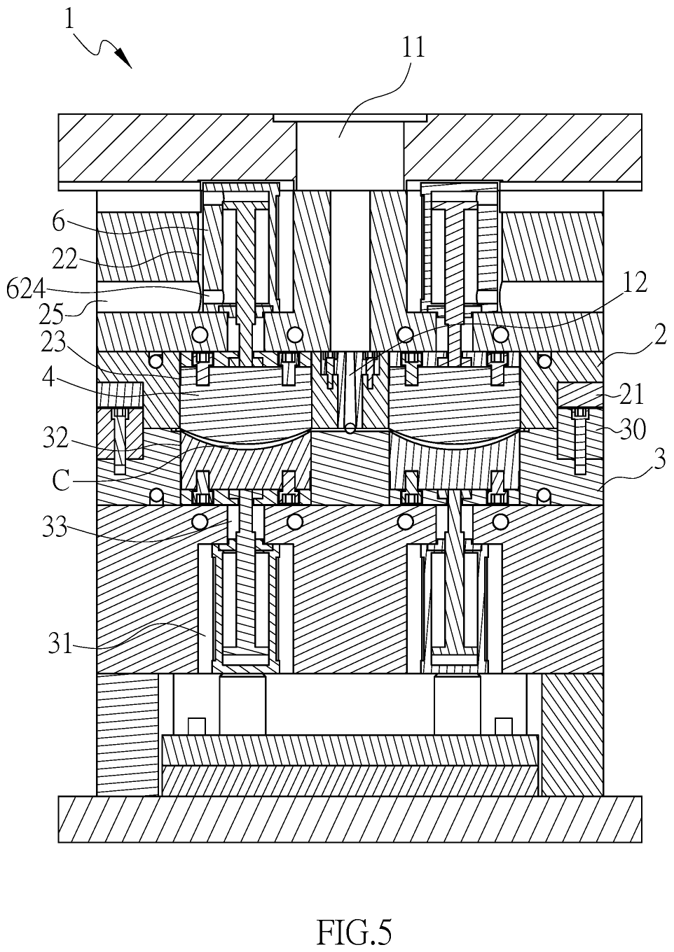

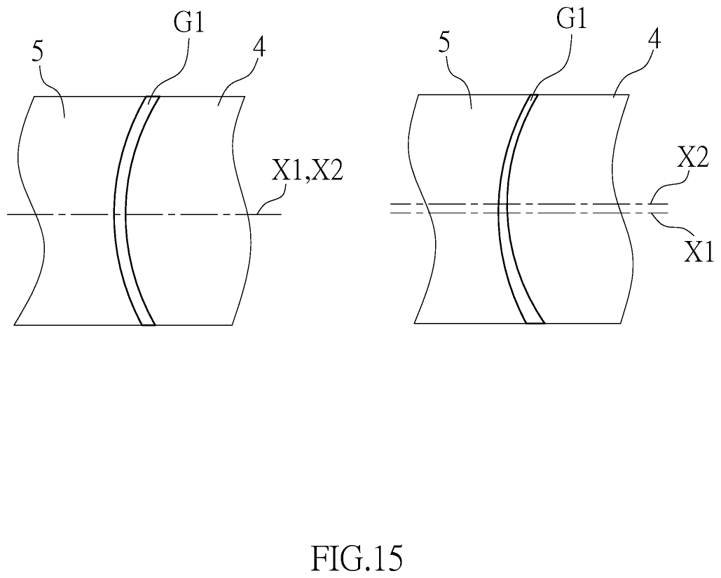

Please refer to FIGS. 5, 7 and 15. A lens is divided into a centric lens G1 and an eccentric lens G2. In order to ensure the correct positioning of the optical axes X1, X2, the bottom of the upper mold core 4 is axially provided with a second positioning slot 44. The upper mold base 2 is provided with a second pin hole 27 coaxially aligned with the second positioning slot 44. A second positioning pin P2 penetrates through the second positioning slot 44 and the second pin hole 27. Hence, the first positioning pin P1 together with the second positioning pin P2 brings about a dual positioning effect. Accordingly, the direction of the upper mold core 4 inserted into the first assembly hole 23 can be correct and accurate, and can be aligned with the lower mold core 5. As a result, the center point of the optical axes X1, X2 of the finished lens can be accurate, and the degree of the finished lens can be correct. It is worth mentioning that when the finished product produced by the mold 1 is of other types, the second positioning pin P2 has a foolproof effect. This allows the operator to have a basis for assembly directionality when replacing the upper mold core 4. In addition, in order to allow the upper mold core 4 to be embedded and separated smoothly, there will be a predetermined gap between the first chute 41 and the first limiting part 623. The gap will affect the above-mentioned optical axes X1, X2. As shown in the partial enlarged view of FIG. 7, the upper section P21 of the second positioning pin P2 is tapered, and the second position slot 44 of the upper mold core is correspondingly tapered. As such, the second positioning pin P2 is inserted into the second positioning slot 44 such that the inclined surface of the second positioning pin P2 is aligned with the inclined surface of the second positioning slot 44. In this way, the upper mold core 4 avoids the problem of looseness due to the gap between the first chute 41 and the first limiting part 623, thereby improving the yield of the finished product.

It is worth mentioning that the number of the upper mold cores 4 can be increased according to the structural design of the mold 1. The drawings of the present disclosure are illustrated by taking the upper mold base 2 together with the upper mold core 4 as an example. Therefore, the number of the first push-pull device 6 and other related components is relatively two, but not limited thereto.

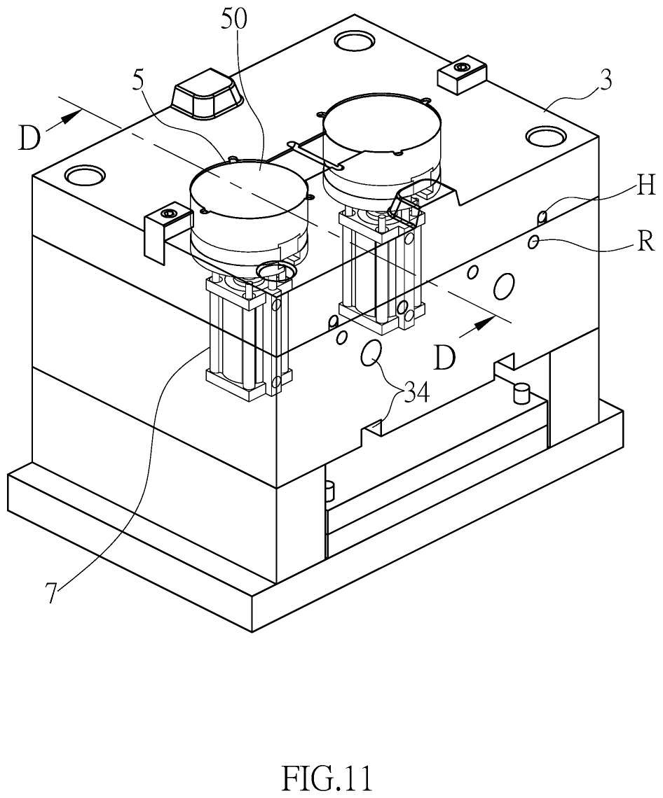

Referring to FIGS. 11-13, which show an embodiment in which both the upper mold base 2 and the lower mold base 3 are provided with a structure for fast replacement of mold cores. Since the structure of the upper mold base 2 is the same as the above, it will not be repeated, and only the structure of the lower mold base 3 will be described below.

In this embodiment, at least one second mounting hole 31 and at least one second assembly hole 32 are provided inside the lower mold base 3. A second channel is provided between the second mounting hole 31 and the second assembly hole 32 to communicate with each other. The lower mold core is arranged in the second assembly hole 32. A second push-pull device 7 is arranged in the second mounting hole 31. The second push-pull device 7 includes a second pressure cylinder 71 and a second push-pull rod 72. One end of the second push-pull rod 72 is a second actuating end 721, which is arranged inside the second pressure cylinder 71. The other end of the second push-pull rod 72 is a second free end 722, which protrudes outside the second pressure cylinder 71. The second free end 722 radially protrudes with a second limiting part 723.

The present disclosure does not limit the type of the second pressure cylinder 71. The second cylinder 71 can be a pneumatic cylinder or a hydraulic cylinder. The second pressure cylinder 71 has two second through holes 73 arranged at intervals and penetrating the wall surface of the second pressure cylinder 71. The two second through hole 72 is respectively adjacent to the top and bottom of the second pressure cylinder 71. The lower mold base 3 is provided with two second passages 34 respectively connected to the second through holes 73. Each of the second passages 34 can be provided with a joint to connect a pressure pump B.

The bottom of the lower mold core 5 is provided with a second chute 51. One side of the second chute 51 penetrates radially to form a second side opening 511. A second stop surface 512 is formed on the other side of the second chute 51. The second chute 51 is provided with a second lower opening 513 at the bottom of the lower mold core 5. The width of the second lower opening 513 is smaller than the width of the second chute 51. A second step part 514 is formed in the second chute 51, and the second lower opening 513 is connected with the second side opening 511 such that the second free end 722 of the second push-pull rod 72 penetrates into the second lower opening 513 of the second chute 51. The second limiting part 723 is arranged in the second chute 51, and placed on the second step part 514, thereby restricting the axial displacement of the lower mold core 5 relative to the lower mold base 3.

Further, the lower mold core 5 is radially provided with a third positioning slot 52. The lower mold base 3 is provided with a third pin hole 35 coaxially communicated with the third positioning slot 52. A third positioning pin P3 detachably passes through the third positioning slot 52 and the third pin hole 35. Herein, when the lower mold core is cylindrical in the drawings, the third positioning pin P3 restricts the radial rotational displacement of the lower mold core 5 relative to the lower mold base 3. Additionally, when the lower mold core 5 has other shapes, such as a cube or a cuboid, the present disclosure has a foolproof function and limits the axial displacement of the lower mold core 5 in the lower mold base 3.

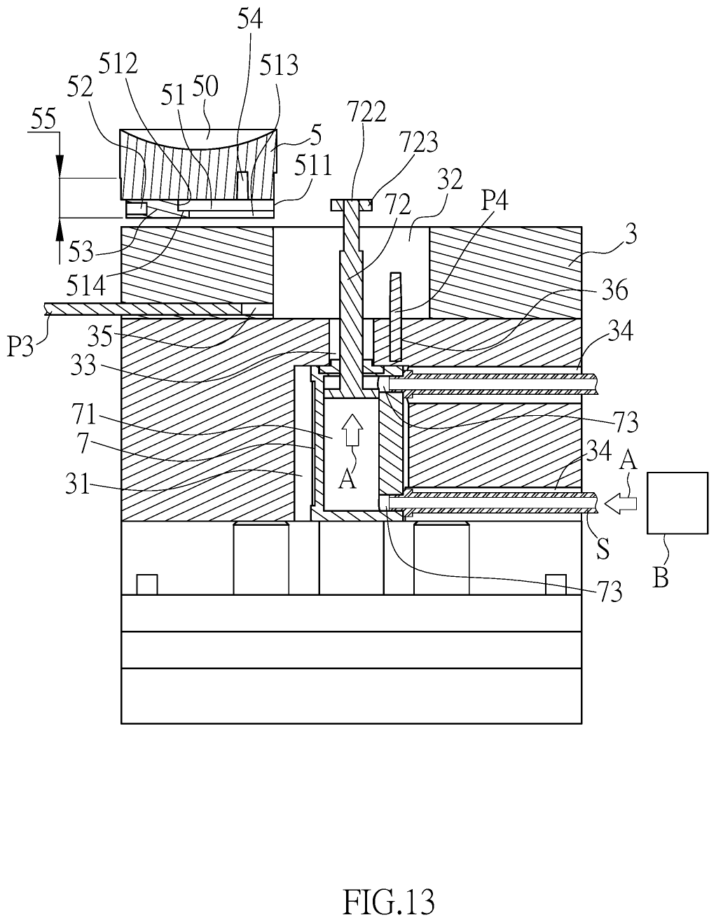

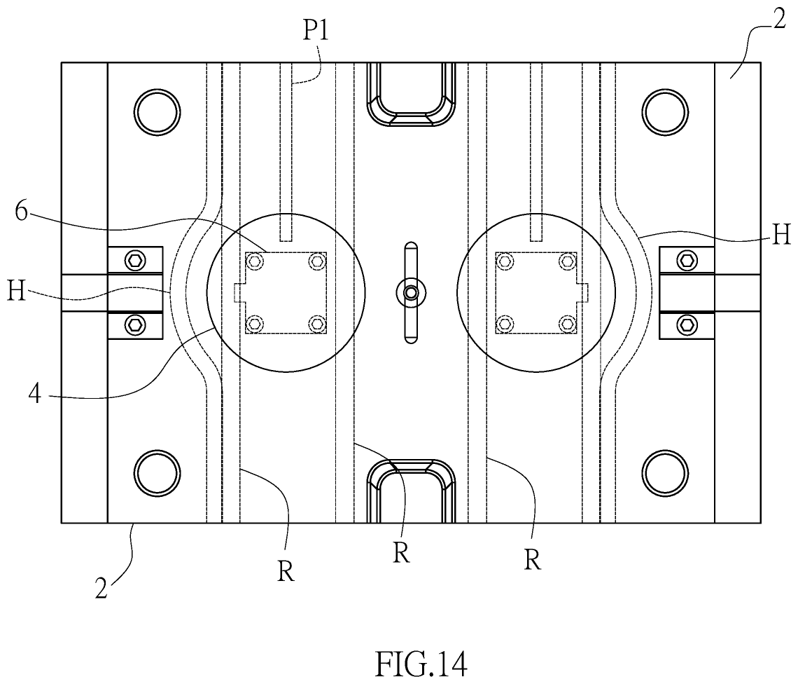

Besides, the second chute 51 and the third positioning slot 52 can be integrally extended by the lower mold core 5 or as shown in FIG. 13. A second gasket 53 is assembled at the bottom of the lower mold core 5. The second gasket 53 has a predetermined thickness, and the second chute 51 is arranged on the first gasket 53. Accordingly, the second gasket 53 of the present disclosure can be replaced with different thicknesses to adjust the thickness of the finished lens without replacing the whole set of the lower mold core 5 such that the lower mold core 5 can achieve the best use efficiency.

Moreover, in order to precisely align and position the optical axis X2 of the lower mold core 5 and the optical axis X1 of the upper mold core 4, the bottom of the lower mold core 5 is axially provided with a fourth positioning slot 54. The lower mold base 3 is provided with a fourth pin hole 36 coaxially aligned with the fourth positioning slot 54. A fourth positioning pin P4 penetrates into the fourth positioning slot 54 and the fourth pin hole 36. The upper section P41 of the fourth positioning pin P4 is tapered, and the fourth positioning slot 54 of the lower mold core 5 is correspondingly tapered. As such, the second mold core 5 is inserted into the second assembly hole 32 such that the inclined surface of the fourth positioning slot 54 is aligned with the inclined surface of the fourth positioning pin P4. In this way, the lower mold core 5 is prevented from loosening due to the gap between the second chute 51 and the second limiting part 723, thereby improving the yield of the finished product.

Furthermore, in order to improve the smoothness when the lower mold core 5 is inserted into the second assembly hole 32, the bottom of the lower mold core 5 has a second introduction section 55. The outer diameter of the second induction section 55 is smaller than the outer diameter of the lower mold core 5 and smaller than the inner diameter of the second assembly hole 32. In this embodiment, the range of the second introduction section 55 covers the bottom of the lower mold core 5 and the second gasket 53. Through the arrange of the second introduction section 55, the problem of interference is reduced when the lower mold core 5 is inserted into the second assembly hole 32.

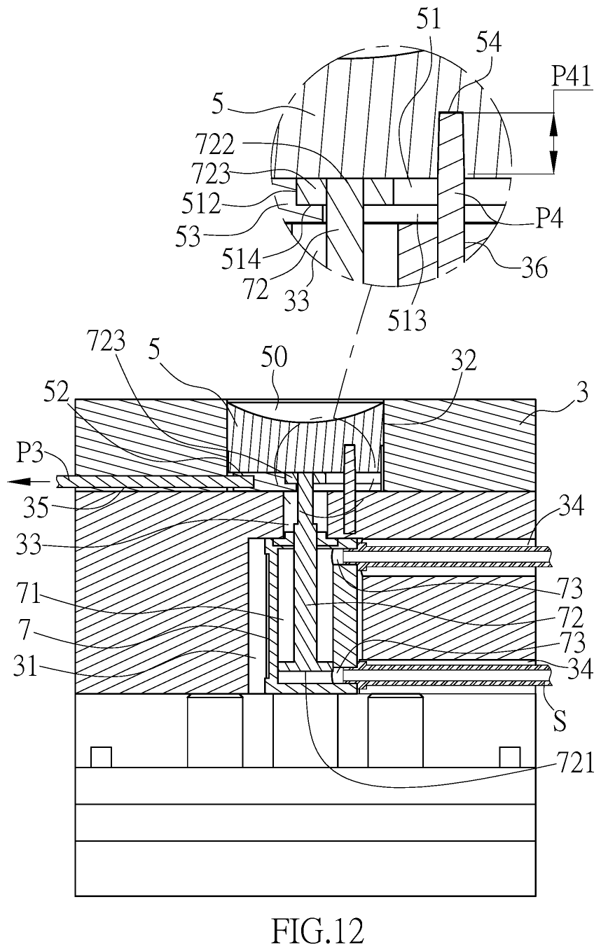

Please refer to FIGS. 12 and 13, when the lower mold core 5 is to be replaced, the third positioning pin P3 must be pulled out of the third positioning slot 52 of the lower mold core 5. After that, the pressure pump b enters the pressure A into the second pressure cylinder 71 through the second through hole 73 at the bottom of the second pressure cylinder 71 so as to push up the second push-pull rod 72 and make the second free end 722 extend out of the second pressure cylinder 71 to drive the lower mold core 5 out of the second assembly hole 32. Subsequently, the lower mold core 5 operably slides along the second side opening 511 of the second chute 51 to the second stop surface 512 such that the lower mold core 5 is separated from the second push-pull rod 72 and the lower mold core 5 is taken out for replacement.

On the contrary, the replaced lower mold core 5 is inserted into the second push-pull rod 72 through the second side opening 511 of the second chute 51, and slides the lower mold core 5 to the outer edge of the second limiting part 723 of the second push-pull rod 72 to abut against the second stop surface 512. The pressure pump B enters the pressure A into the second pressure cylinder 71 through the second through hole 73 at the top of the second pressure cylinder 71 to return the second push-pull rod 72 to its original position. The second free end 722 is relatively retracted and the lower mold core is inserted into the second assembly hole 32. The third positioning pin P3 is embedded in the third position slot 52 to complete the procedure of replacing the lower mold core 5.

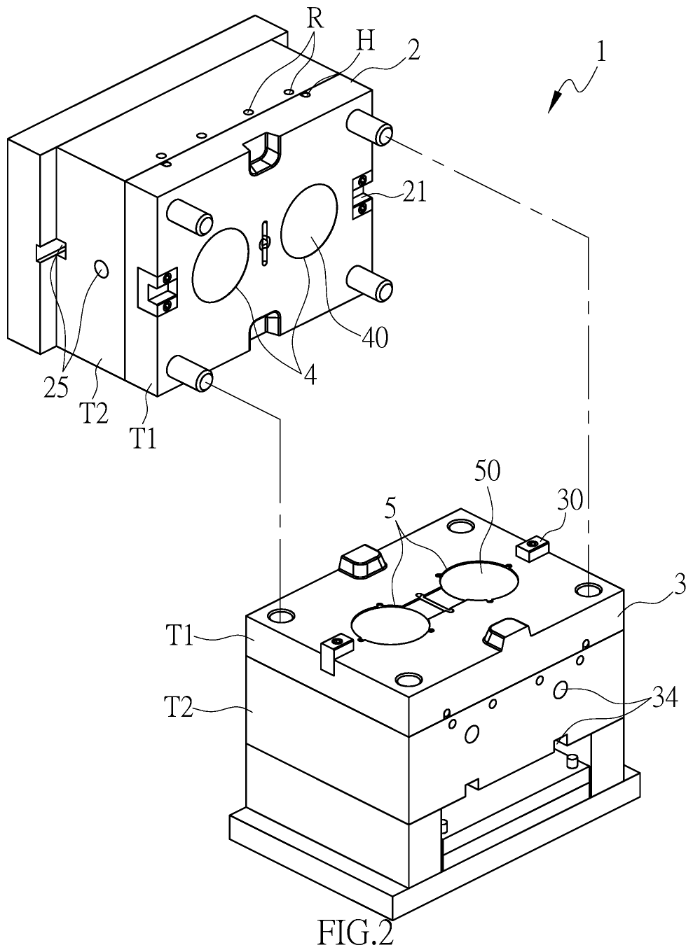

The present disclosure does not limit the number of the lower mold cores 5. Two lower mold cores 5 and two second push-pull devices are illustrated in the drawings, but not limited thereto. The upper mold base 2 and the lower mold base 3 are composed of a plurality of templates (T1 and T2), as shown in FIGS. 1 and 2, but they are not used to limit their composition structure. In addition, the upper mold base 2 and the lower mold base 3 are respectively provided with electric heating tubes H adjacent to the upper mold core 4 and the lower mold core 5. A plurality of cooling water paths are provided at the predetermined position such that the upper mold core 4 and the lower mold core 5 can achieve optimal temperature control. Moreover, the sprue 11 and raw material flow channel 12 of the mold 1 are displayed on the upper mold base 2, but not limited thereto. According to the structure of the finished product and the design of the mold, they can be arranged in the appropriate positions. It is worth mentioning that the present disclosure can be applied to large-scale products or small-scale products. When the present disclosure is applied to large-scale products, it is only necessary to set the push-pull device to an appropriate ratio in accordance with the size and weight of the mold core.

In summary, in the present disclosure, the upper mold base 2 and the lower mold base 3 have a structure for quickly disassembling the mold cores such that the present disclosure can save man-hours and manpower when replacing the mold cores. Taking the production of lenses as an example, in the production of small batch or customized lens, the mold cores can be quickly replaced though the structure of the present disclosure, thereby improving the production efficiency and shortening the time for replacing the mold cores. Due to the long waiting time for mold replacement, the raw material of the material tube is cracked, and the material tube needs to be cleaned. The present disclosure solves such problem of the prior art.

Although the present disclosure has been described with reference to the preferred exemplary preferred embodiments thereof, it is apparent to those skilled in the art that a variety of modifications and changes may be made without departing from the scope of the present disclosure which is intended to be defined by the appended claims.

What is claimed is:

1. A mold structure with a fast replacement of a mold core, comprising:
an upper mold base and a lower mold base corresponding to the upper mold base, wherein at least one upper mold core is provided inside the upper mold base, and at least one lower mold core is provided inside the lower mold base and corresponded to the upper mold core,
wherein the upper mold base is provided with a first push-pull device corresponding to a bottom of the upper mold core, the first push-pull device includes a first pressure cylinder and a first push-pull rod capable of expansion and contraction arranged in the first pressure cylinder, one end of the first push-pull rod is a first free end and protrudes out of the first pressure cylinder, and the upper mold core is driven by the expansion and contraction of the first push-pull rod, and is relatively separated from or embedded in the upper mold base, and
wherein the bottom of the upper mold core is provided with a first chute, and the upper mold core is operatively coupled with or separated from the first free end of the first push-pull rod by the first chute.

2. The mold structure with the fast replacement of the mold core of claim 1, wherein the first free end of the first push-pull rod is radially provided with a first limiting part, one side of the first chute is radially provided with a first side opening, another side of the first chute is provided with a first stop surface, the bottom of the upper mold core is provided with the first chute, the first chute is provided with a first lower opening, a width of the first lower opening is smaller than a width of the first chute, a first step part is provided in the first chute, and the first lower opening connects with the first side opening such that the first free end of the first push-pull rod penetrates the first lower opening of the first chute, and the first limiting part is arranged in the first chute and limited to the first step part.

3. The mold structure with the fast replacement of the mold core of claim 2, wherein a first gasket is assembled at the bottom of the upper mold core, the first gasket has a predetermined thickness, and the first chute is arranged on the first gasket.

4. The mold structure with the fast replacement of the mold core of claim 1, wherein the upper mold core is radially provided with a first positioning slot, the upper mold base is provided with a first pin hole coaxially connected to the first positioning slot, and a first positioning pin is detachably inserted the first positioning slot and the first pin hole.

5. The mold structure with the fast replacement of the mold core of claim 1, wherein a second positioning slot is axially provided at the bottom of the upper mold core, the upper mold base is provided with a second pin hole coaxially aligned with the second positioning slot, and a second positioning pin passes through the second positioning slot and the second pin hole.

6. The mold structure with the fast replacement of the mold core of claim 5, wherein an upper section of the second positioning pin is tapered, and the second positioning slot of the upper mold core is correspondingly tapered.

7. The mold structure with the fast replacement of the mold core of claim 1, wherein a second push-pull device is provided inside the lower mold base corresponding to a bottom of the lower mold core, the second push-pull device includes a second pressure cylinder and a second push-pull rod capable of expansion and contraction arranged in the second pressure cylinder, one end of the second push-pull rod is a second free end and protrudes out of the second pressure cylinder, and the lower mold core is driven by the expansion and contraction of the second push-pull rod, and is relatively separated from or embedded in the lower mold base, the bottom of the lower mold core is provided with a second chute, and the lower mold core is operatively coupled with or separated from the second end of the second push-pull rod by the second chute.

8. The mold structure with the fast replacement of the mold core of claim 7, wherein the second free end of the second push-pull rod is radially provided with a second limiting part, one side of the second chute is radially provided with a second side opening, another side of the second chute is provided with a second stop surface, the bottom of the lower mold core is provided with the second chute, the second chute is provided with a second lower opening, a width of the second lower opening is smaller than a width of the second chute, a second step part is provided in the second chute, and the second lower opening connects with the second side opening such that the second free end of the second push-pull rod penetrates the second lower opening of the second chute, and the second limiting part is arranged in the second chute and limited to the second step part.

9. The mold structure with the fast replacement of the mold core of claim 8, wherein a second gasket is assembled at the bottom of the lower mold core, the second gasket has a predetermined thickness, and the second chute is arranged on the second gasket.

10. The mold structure with the fast replacement of the mold core of claim 7 wherein the lower mold core is radially provided with a third positioning slot, the lower mold based is provided with a third pin hole coaxially connected to the third positioning slot, and a third positioning pin detachably passes through the third positioning slot and the third pin hole.

11. The mold structure with the fast replacement of the mold core of claim 7, wherein a fourth positioning slot is axially provided at the bottom of the lower mold core, the lower mold based is provided with a fourth pin hole coaxially aligned with the fourth positioning slot, and a fourth positioning pin passes through the fourth positioning slot and the fourth pin hole.

12. The mold structure with the fast replacement of the mold core of claim 11, wherein an upper section of the fourth positioning pin is tapered, and the fourth positioning slot of the lower mold core is correspondingly tapered.
